(19) United States
(12) Patent Application Publication
(10) Pub. No.: US 2021/0396947 A1
(43) Pub. Date: Dec. 23, 2021

(54) SLIDE ACTUATOR

(71) Applicant: OLYMPUS CORPORATION, Tokyo (JP)

(72) Inventor: Ken OGATA, Tokyo (JP)

(73) Assignee: OLYMPUS CORPORATION, Tokyo (JP)

(21) Appl. No.: 17/462,506

(22) Filed: Aug. 31, 2021

Related U.S. Application Data
(63) Continuation of application No. PCT/JP2019/008873, filed on Mar. 6, 2019.

(51) Int. Cl. G02B 7/02; H02K 41/035

(52) U.S. Cl. CPC G02B 7/02; H02K 41/0356

(57) ABSTRACT

A slide actuator includes: a fixed member; a movable member movable to the fixed member by a predetermined stroke in a predetermined direction; a plurality of balls interposed between the fixed member and the movable member and configured to movably support the movable member; and paired elastic bodies disposed at both ends of a moving range of each of the balls, each of the elastic bodies being configured to come into contact with the corresponding ball when the balls move with movement of the movable member.

### CROSS REFERENCE TO RELATED APPLICATION

This application is a continuation application of PCT/JP2019/008873 filed Mar. 6, 2019, the entire contents of which are incorporated herein by this reference.

### BACKGROUND OF INVENTION

### 1. Field of the Invention

The present invention relates to a slide actuator that supports a movable member through balls so as to be movable to a fixed member.

### 2. Description of the Related Art

A slide actuator that holds a moved body (for example, optical device) to a movable member disposed to be slidable to a fixed member, and reciprocates the movable body while maintaining an attitude of the moved body orthogonal to a moving direction has been conventionally known, and is adopted for a well-known voice coil motor (VCM) and the like.

For example, Japanese Patent Application Laid-Open Publication No. H8-29656 discloses a technique that moves a plurality of halls along V-grooves (guide grooves) in an apparatus driving a lens in an optical axis direction by the VCM.

In this case, intervals among the plurality of balls are retained constant by a retainer. For example, in a slide actuator 101 illustrated in FIG. 8A and FIG. 8B, a movable member 103 are supported through a plurality of balls 105 so as to be linearly movable to a fixed member 102 fixed to an apparatus main body. A retainer 104 is fixed to a surface of the movable member 103 facing the fixed member 102, and the retainer 104 includes ball housing portions 104a allowing movement of the balls 105. In addition, the movable member 103 includes V-grooves 103a guiding the balls 105.

As illustrated in a left part of FIG. 9, when the movable member 103 linearly moves on the fixed member 102 in a direction of a void arrow, the balls 105 move by a moving amount of one-half of a moving amount of the movable member 103, by rolling frictions f1 and f2 with the movable member 103 and the fixed member 102. As illustrated in FIG. 10A, a width W of each of the ball housing portion 104a in the moving direction is set to a value at which the balls 105 do not conic in contact with wall parts 104b even when the balls 105 move following linear reciprocation of the movable member 103.

In this case, when disturbance such as vibration is applied from the apparatus main body to the fixed member 102, the halls 105 are gradually easily displaced toward the wall parts 104b of the ball housing portions 104a as illustrated in FIG. 10B. At this time, for example, when large disturbance acts on the fixed member 102 as illustrated by a void arrow in FIG. 10C and the balls 105 come into contact with the wall parts 104b of the ball housing portions 104a, sliding frictions f2 and f3 easily occur between each of the balls 105 and the fixed member 102 and between each of the balls 105 and the corresponding wall part 104b of the ball housing portion 104a.

### SUMMARY OF THE INVENTION

A slide actuator according to an aspect of the present invention includes: a fixed member; a movable member movable to the fixed member by a predetermined stroke in a predetermined direction; a plurality of balls interposed between the fixed member and the movable member and configured to movably support the movable member, each of the balls being disposed in the movable member; and paired elastic bodies disposed at both ends of a moving range of each of the balls, each of the elastic bodies being configured to come into contact with the corresponding ball when the balls move with movement of the movable member.

A lens driving apparatus according to another aspect of the present invention includes: a slide actuator including a fixed member, a movable member movable to the fixed member by a predetermined stroke in a predetermined direction, a plurality of balls interposed between the fixed member and the movable member and configured to movably support the movable member, each of the balls being disposed in the movable member, and paired elastic bodies disposed at both ends of a moving range of each of the balls, each of the elastic bodies being configured to come into contact with the corresponding ball when the balls move with movement of the movable member; a lens; a magnet; and a coil, wherein, the movable member holds the lens, the magnet is fixed to a periphery of the movable member, and the coil is wound around an outer periphery of the fixed member.

### BRIEF DESCRIPTION OF THE DRAWINGS

FIG. 1 is a side view illustrating a schematic configuration of a slide actuator according to a first embodiment;

FIG. 2 is a perspective view specifically illustrating a movable member of the slide actuator according to the first embodiment;

FIG. 3 is a cross-sectional view taken along line in FIG. 2 according to the first embodiment;

FIG. 4 is an explanatory diagram illustrating relationship of static frictional force acting between a fixed member and a movable member with an amount of spring force acting on a wire spring when a ball is pressed against the wire spring according to the first embodiment;

FIG. 5A is a plan view illustrating moving ranges of balls when the movable member normally linearly reciprocates according to the first embodiment;

FIG. 5B is a plan view illustrating a state where the balls abut on wire springs according to the first embodiment;

FIG. 5C is a plan view illustrating a state where the balls press the wire springs according to the first embodiment;

FIG. 6 is a characteristic diagram illustrating a displacement amount and the amount of spring force of a wire spring according to the first embodiment;

FIG. 7A is a plan view illustrating moving ranges of balls when a movable member normally linearly reciprocates according to a second embodiment and corresponding to FIG. 5A;

FIG. 7B is a plan view illustrating a state where the balls abut on coil springs according to the second embodiment and corresponding to FIG. 5B;

FIG. 7C is a plan view illustrating a state where the balls press the coil springs according to the second embodiment and corresponding to FIG. 5C;

FIG. 8A is a schematic side view of a slide actuator according to a conventional embodiment;

FIG. 8B is a cross-sectional view taken along line B-B in FIG. 8A according to the conventional embodiment;

FIG. 9 is a schematic diagram to explain a state of frictions acting between a ball and a fixed member and between the ball and a movable member according to the conventional embodiment;

FIG. 10A is a plan view illustrating moving ranges of balls housed in ball housing portions of a retainer fixed to a movable member that normally linearly reciprocates according to the conventional embodiment;

FIG. 10B is a plan view illustrating a state where the balls abut on wall parts of the ball housing portions according to the conventional embodiment; and

FIG. 10C is a plan view illustrating a state where the balls press the wall parts of the ball housing portions according to the conventional embodiment.

### DETAILED DESCRIPTION OF THE PREFERRED EMBODIMENTS

Some embodiments of the present invention are described below with reference to drawings. Note that the drawings are schematic, and relationship between a thickness and a width of each member, ratios of thicknesses of respective members, and the like are different from relationship and ratios of actual members. Portions having dimensional relationship and ratios different from one another are included among the drawings as a matter of course.

### First Embodiment

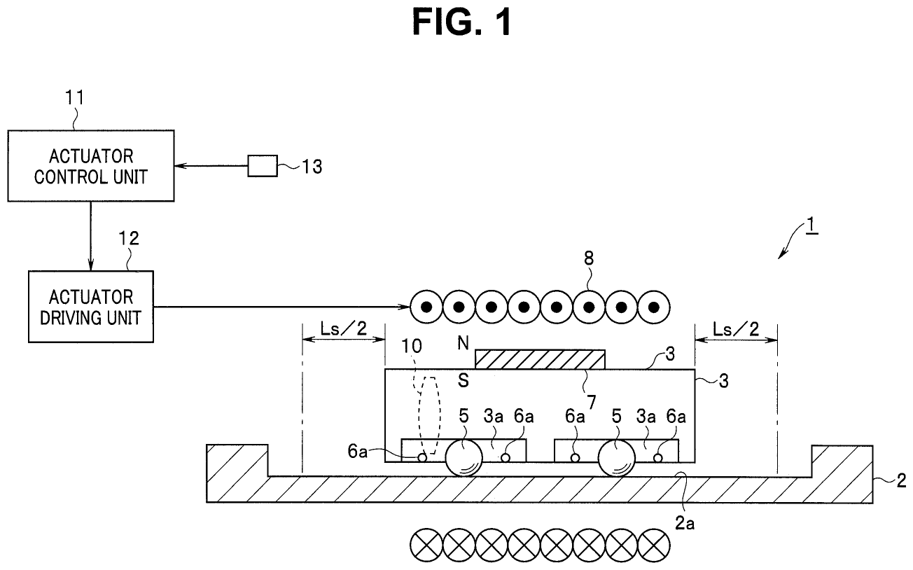

FIG. 1 to FIG. 6 illustrate a first embodiment of the present invention. First, a reference numeral 1 in FIG. 1 denotes an electromagnetic slide actuator. The slide actuator includes a fixed member 2 fixed to an unillustrated apparatus main body, a movable member 3 linearly movable on an inner surface 2a of the fixed member 2 by a predetermined stroke Ls, and a plurality of balls 5 that are interposed between the fixed member 2 and the movable member 3 and movably support the movable member 3.

The balls 5 are housed one by one in ball housing portions 3a provided in the movable member 3. Although not illustrated, guide grooves (V-grooves) linearly guiding movement of the balls 5 are provided on the inner surface 2a of the fixed member 2 and surfaces of the ball housing portions 3a facing the inner surface 2a.

The movable member 3 holds, for example, an optical device 10 as a moved body, and a permanent magnet 7 is fixed to a periphery of the movable member 3. In addition, a coil 8 is disposed at a position separated by a distance where the coil 8 receives an appropriate magnetic field from the permanent magnet 7 so as to face an outer periphery of the permanent magnet 7. The coil 8 is wound around an outer periphery of the fixed member 2. Note that the slide actuator 1 according to the present embodiment is of a movable magnet type. However, the slide actuator may be of a movable coil type in which a coil is attached to the movable member 3 and the permanent magnet faces the coil.

An output side of an actuator control unit 11 is connected to the coil 8 through an actuator driving unit 12. Further, a position detection sensor 13 that detects a movement position of the movable member 3 is connected to an input side of the actuator control unit 11.

The actuator control unit 11 mainly includes a well-known microcomputer including a CPU, a ROM, a RAM, and an interface, each well-known. The actuator control unit 11 compares actual positional information of the movable member 3 detected by the position detection sensor 13 with a movable member instruction value set as a target position, and outputs a control signal to correct a control deviation to the actuator driving unit 12.

Then, the actuator driving unit 12 outputs a driving current corresponding to the control signal to the coil 8, and Lorentz force is generated by the magnetic field of the permanent magnet 7, which slides the movable member 3. A moving direction of the movable member 3 is determined by a direction of the current applied to the coil 8, and magnitude of force of the movable member 3 is changed by an amount of the current.

For example, when the actuator driving unit 12 applies the movable member instruction value (driving current) of a sine wave to the coil 8 in response to a PWM signal outputted from the actuator control unit 11, the movable member repeats linear reciprocation in a predetermined direction by the predetermined stroke Ls. In this case, in a case where it is assumed that slippage does not occur between the movable member 3 and each of the balls 5 and between each of the balls 5 and the inner surface 2a of the fixed member 2, each of the balls 5 reciprocates following the movable member 3 by a moving amount of one-half of the moving amount of the movable member 3.

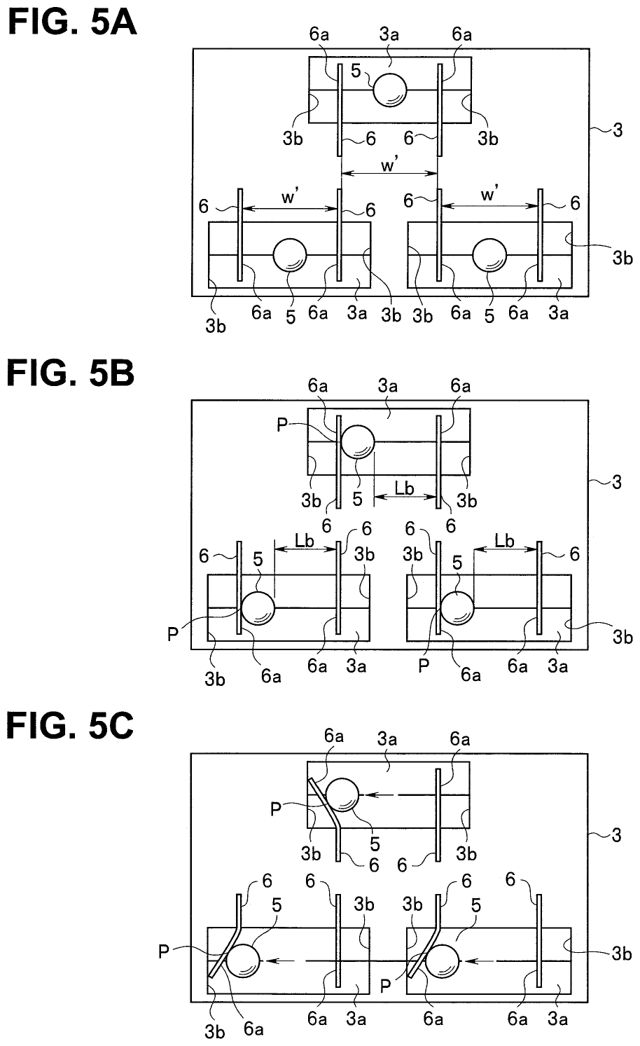

Further, free ends 6a of a pair of wire springs 6 as elastic bodies protrude to each of the ball housing portions 3a, at both ends of a moving range Lb of each of the balls 5. In each of the ball housing portions 3a, the free ends 6a face a center between the inner surface 2a of the fixed member 2 and an opposing surface of the ball housing portion 3a with Which the corresponding ball 5 come into contact in a diameter direction, and a position of each of the free ends 6a becomes a contact point P described below. Therefore, an interval W′ (see FIG. 5A) between opposing surfaces of the free ends 6a is set to at least a value obtained by adding the moving range Lb to the diameter of each of the balls 5 (see FIG. 5B), and the free ends 6a are disposed at an interval slightly greater than the value.

When each of the balls 5 comes into contact with the corresponding free end 6a at a predetermined pressure or more, the free end 6a elastically deforms and buffers the pressure applied from the ball 5 at the contact point P (see FIG. 5C). Wall parts 3b face the respective free ends 6a at a predetermined interval in a deformation direction. The wall parts 3b function as restriction members for preventing the respective free ends 6a from deforming (plastically deforming) beyond an elastic limit.

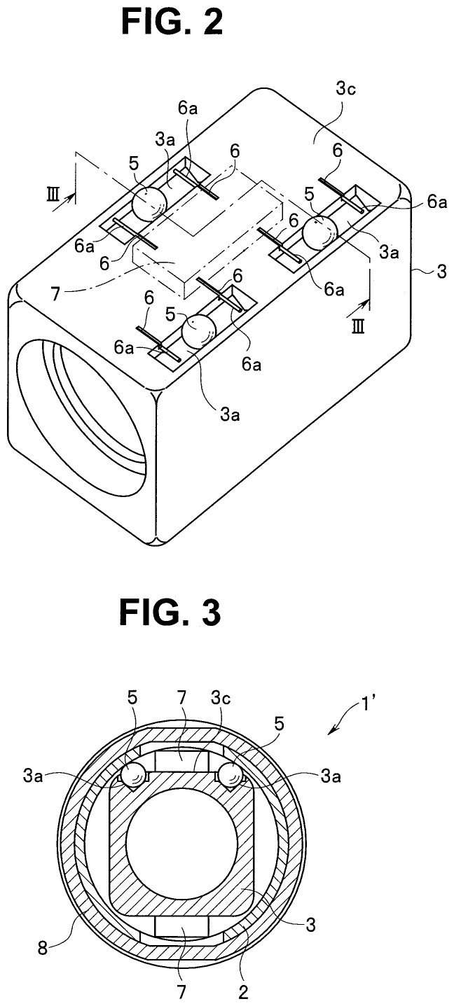

FIG. 2 and FIG. 3 each illustrate a specific shape in a case where the above-described slide actuator 1 is adopted as a voice coil motor (VCM) 1′. The voice coil motor 1′ functions as, for example, a lens driving apparatus driving a lens. In the voice coil motor 1′, the movable member 3 holding the lens, etc. is formed in a square cylindrical shape, and the permanent magnet 7 is attached to each of two opposing surfaces of the movable member 3.

The fixed member 2 supports the movable member 3 so as to be movable in an optical axis direction, and the fixed member 2 includes notches allowing movement of the permanent magnets 7 in an axial direction. Further, the coil 8 is wound around the outer periphery of the fixed member 2 within a range wider than a value obtained by adding the moving range to a length of each of the permanent magnets 7 in the axial direction.

On the other hand, in the movable member 3, the ball housing portions 3a integrally provided with the guide grooves are provided at both edge parts in a direction orthogonal to the moving direction (hereinafter, referred to as “short direction”) on a side surface 3c of the movable member 3.

In the present embodiment, the movable member 3 are supported by three balls 5 (three-point supporting). Therefore, the ball housing portions 3a are provided at two positions at one of the edge parts and at one position at the other edge part in the short direction of the side surface 3c. Further, the two ball housing portions 3a provided at one of the edge parts are provided at symmetrical positions with a center in a direction along movement of the movable member 3 (hereinafter, referred to as “longitudinal direction”), in between. The ball housing portion 3a provided at the other edge part is provided at the center in the longitudinal direction.

As illustrated in FIG. 2, in the present embodiment, the six wire springs 6 in total that are disposed one pair by one pair in the ball housing portions 3a are held in a cantilever manner by the side surface 3c while being orthogonal to the moving direction of the movable member 3. As illustrated in FIG. 5A, the wire springs 6 are disposed at equal intervals W′, and each of the wire springs 6 has, at one end part, the free end 6a protruding to the corresponding ball housing portion 3a.

As described above, each of the free ends 6a of the wire springs 6 elastically deforms to buffer impact when the balls 5 collide with the respective free ends 6a. The deformation can reduce generation of sliding frictions of each of the balls 5. A spring constant k of each of the free ends 6a (substantially, each of wire springs 6) is set within a range represented by the following inequality (1).

Although not illustrated, pressure lightly urging each of the balls 5 against the inner surface 2a of the fixed member 2 is generated in the movable member 3 in a non-contact state using repulsive force, attraction force, or the like of the magnet.

(Fx/x2)<k≤(Fx/x1) (1)

where x1<x2 is established.

Further, the value Fx is represented by the following equation.

Fx=(μ1·M·g)/n+(μ2(m·g+M·g))n (2)

In the equation, Fx is maximum static frictional force generated between the movable member 3 and the inner surface 2a of the fixed member 2 per one ball 5. μ1 is a maximum static friction coefficient between the movable member 3 and the balls 5, μ2 is a maximum static friction coefficient between the balls 5 and the inner surface 2a of the fixed member 2, M is a mass of the movable member 3, m is a mass of the balls 5, g is gravitational acceleration, n is the number of balls 5, x1 is a displacement amount of the contact point P between the free end 6a of each of the wire springs 6 and the corresponding ball 5 generated by the predetermined stroke of the movable member 3, and x2 is a displacement amount of the contact point P between the free end 6a of each of the wire springs 6 and the corresponding ball 5 at the elastic limit of the free end 6a of each of the wire springs 6.

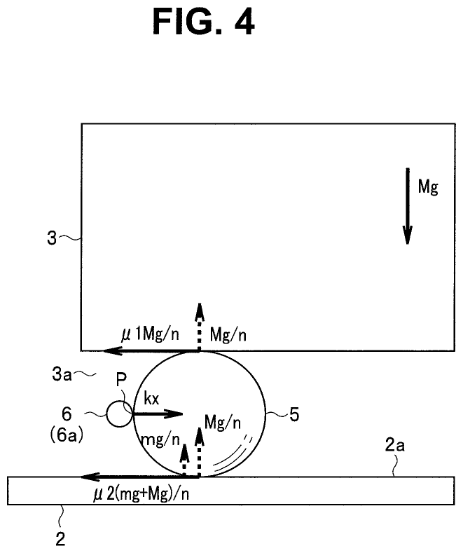

FIG. 4 schematically illustrates action of the force represented by the above-described equation (2). In this case, the mass M of the movable member 3 includes a mass of the optical device 10 as the mounted moved body. Further, in a case where the movable member 3 lightly urges each of the balls 5 against the inner surface 2a of the fixed member 2 by repulsive force, attraction force, and the like of the magnet, the urging force is included in the mass M, which makes it possible to set the spring constant k with higher accuracy.

According to the inequality (1), in a case where the spring displacement amount x is equal to x1 (x=x1), under a condition that each of the wire springs 6 is the hardest, the amount of spring force (reaction force) k·x pushing back the corresponding ball 5 when the spring displacement amount exceeds a predetermined amount even a little, in other words, the amount of spring force k·x not pushing back the corresponding ball when the amount of spring force is within the predetermined amount, is represented as follows.

k·x≤Fx

Further, in a case where the spring displacement amount x is equal to x2 (x=x2), a condition that each of the wire springs 6 is the softest, in other words, the amount of spring force k·x pushing back the corresponding ball 5 before the spring displacement amount reaches a plastic region, is represented as follows.

Fx>k·x

In this case, the free end 6a of each of the wire springs 6 is plastically deformed at x≥x2. Therefore, an actual usable range is x<x2,

In the case where the slide actuator 1 is the voice coil motor 1′, urging force f in a slide direction acts on the movable member 3. Therefore, the equation (2) is turned into an equation (2′).

Fx=(μ1(M·g+f))/n+(μ2(m·g+M·g+f))/n (2′)

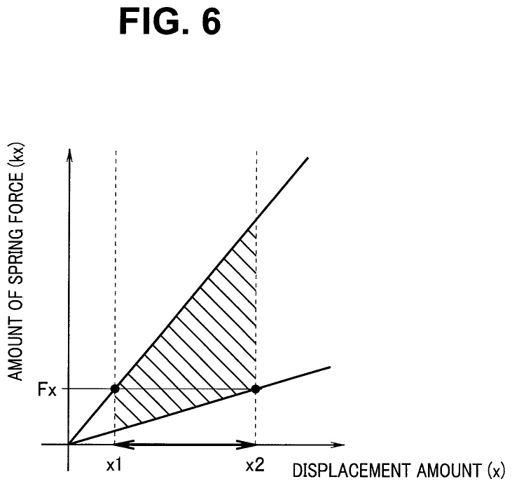

FIG. 6 illustrates relationship between the displacement amount x and the amount of spring force k·x of each of the wire springs 6 in a case where the value Fx determined by the equation (2′) is applied to the inequality (1). The spring constant k is set based on the preset Fx (amount of spring force k·x acts in opposite direction, see FIG. 4) between the displacement amounts x1 and x2 in an area surrounded by inclinations of linear lines (limit values of spring constant k) at which sliding frictions is not generated in each of the balls 5, set by the above-described inequality (1).

For example, as illustrated in FIG. 6, in a case where a vertical axis represents the force Fx acting on each of the balls 5, when the spring constant (inclination) k is set within a range between the displacement amounts x1 and x2, the sliding frictions generated in each of the balls 5 is suppressed. In addition, each of the wire springs 6 (each of free ends 6a) can buffer impact within the elastic deformation range without plastically deforming.

Next, action according to the present embodiment having such a configuration is described. The actuator control unit 11 compares the actual positional information of the movable member 3 detected by the position detection sensor 13 with the movable member instruction value set as the target position, and outputs the control signal to correct the control deviation to the actuator driving unit 12. Then, the actuator driving unit 12 applies the corresponding movable member instruction value (driving current) to the coil 8, and linearly reciprocates the movable member 3 within the range of the stroke Ls.

When the movable member 3 moves, each of the balls 5 rotates by the rolling frictions, and reciprocates in the moving range Lb (=Ls/2) of one-half of the stroke L2 as the moving range of the movable member 3, following the movable member 3. In a case where each of the balls 5 follows the movement of the movable member 3 without generating sliding frictions, each of the balls 5 performs following operation within the moving range surrounded by the free ends 6a of the wire springs 6 protruding to the corresponding ball housing portion 3a.

However, when the control deviation of the movable member 3 is increased, displacement accordingly occurs in each of the balls 5, and each of the halls 5 is displaced in a direction toward the free end 6a of one of the corresponding wire springs 6 as illustrated in FIG. 5B. At this time, when the control deviation of the movable member 3 is increased due to influence of disturbance and the like, the displacement of each of the balls 5 is increased, and each of the balls 5 collide with the free end 6a of one of the corresponding wire springs 6 at the contact point P as illustrated in FIG. 5C. As a result, each of the free ends 6a elastically deforms by the pressing force applied to the contact point P, and buffers the impact.

At this time, the spring constant k of each of the wire springs 6 is set within the range of the inequality (1) based on the preset amount of spring force k·x (see FIG. 6), which suppresses generation of the sliding frictions of each of the balls 5 and reduces the control deviation of the movable member 3. Further, suppression of the sliding frictions of each of the balls 5 makes it possible to suppress deterioration of abrasion resistance.

In a case where each of the balls 5 applies force exceeding the set amount of spring force k·x to the free end 6a of one of the corresponding wire springs 6, the free end 6a is caught by the wall part 3b of the corresponding ball housing portion 3a and further deformation is restricted. Therefore, the free end 6a does not plastically deform and is not damaged.

As described above, according to the present embodiment, even in the case where each of the wire springs 6 receives impact from the corresponding ball 5, setting the spring constant k of each of the wire springs 6 within the range of the inequality (1) based on the preset amount of spring force k·x makes it possible to buffer the impact by elastic deformation of the free ends 6a in the state where the sliding frictions generated in each of the balls 5 are suppressed. Further, reducing the sliding frictions generated in the balls 5 makes it possible to improve durability and to realize prolongation of lifetime.

Note that in the present embodiment, the wire springs 6 are illustrated and described as elastic bodies; however, the elastic bodies may be plate springs or wire rubbers.

### Second Embodiment

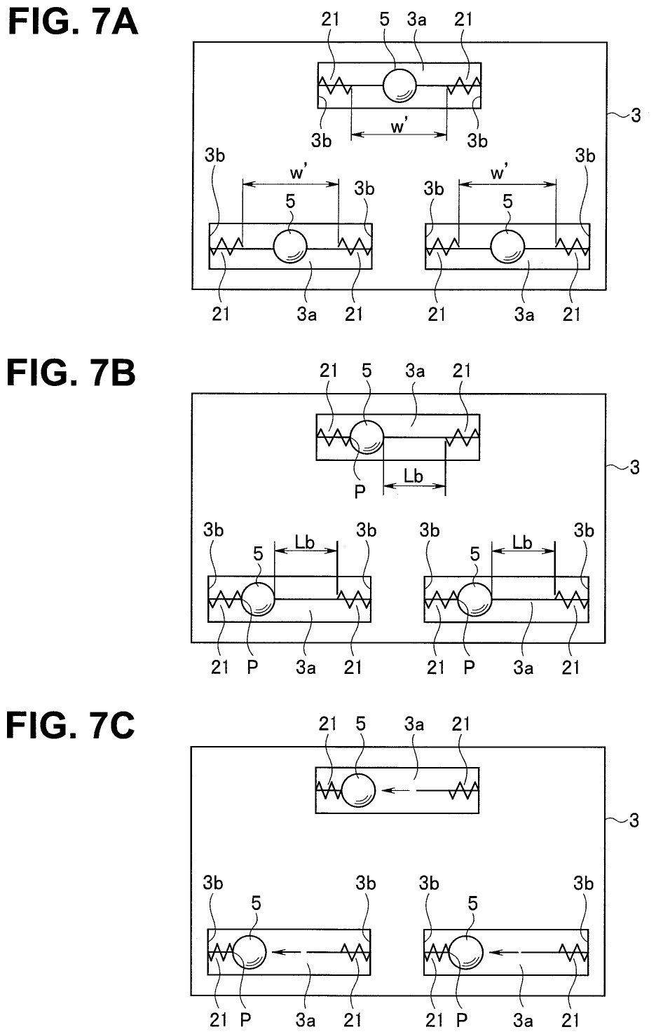

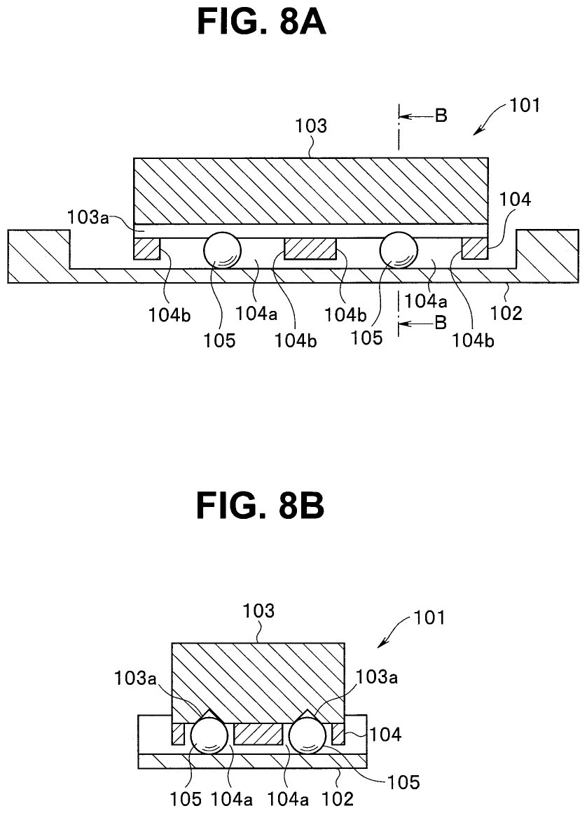

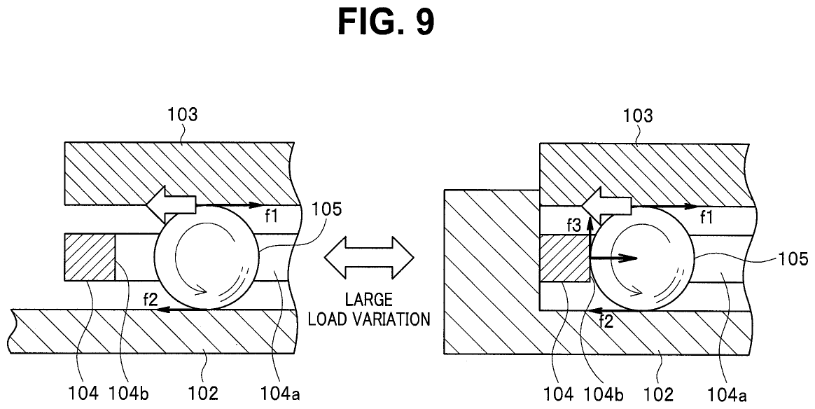

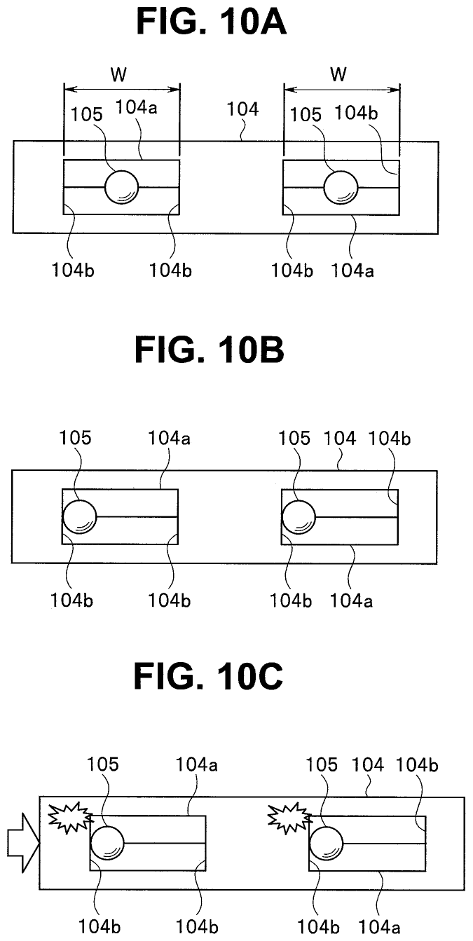

FIG. 7 illustrates a second embodiment of the present invention. Note that the components same as the components in the first embodiment are denoted by the same reference numerals, and descriptions of the components are simplified or omitted.

In the above-described first embodiment, the wire springs 6 are adopted as the elastic bodies and are disposed in a cantilever manner in the direction orthogonal to the moving direction of the movable member 3. The impact applied from the balls 5 are buffered by the elastic deformation of the respective free ends 6a provided at the end parts of the wire springs 6.

In contrast, in the present embodiment, paired compression springs 21 facing each other are provided as the elastic bodies in both wall parts 3b provided in each of the ball housing portions 3a of the movable member 3. A spring constant k of each of the compression springs 21 is determined from the above-described inequality (1). In addition, a free length of each of the compression springs 21 from the corresponding wall part 3b is set to a length of a position of the free end 6a of each of the wire springs 6 described in the first embodiment. Further, each of the compression springs 21 at a solid length functions as a restriction member.

In such a configuration, when the movable member 3 linearly reciprocates within the range of the stroke Ls, each of the balls 5 reciprocates in the moving range Lb (=Ls/2) of one-half of the moving range of the movable member 3, following the movable member 3. In the case where each of the balls 5 follows the movement of the movable member 3 without generating sliding frictions, each of the balls 5 performs the following operation between the corresponding both compression springs 21, as illustrated in FIG. 7A.

However, when the control deviation of the movable member 3 is increased, displacement accordingly occurs in each of the balls 5, and each of the balls 5 is displaced in a direction toward one of the corresponding compression springs 21 as illustrated in FIG. 7B. At this time, when the control deviation of the movable member 3 is increased due to influence of disturbance and the like, the displacement of each of the balls 5 is increased, and each of the balls 5 press one of the corresponding compression springs 21 at the contact point P as illustrated in FIG. 7C. Note that the positions of the contact points P pressed by the respective balls 5 are set to the positions same as the positions in the first embodiment.

Then, each of the compression springs 21 elastically deforms by the pressing force applied to the contact point P, and buffers the impact. At this time, the spring constant k of each of the compression springs 21 is set within the range of the inequality (1) based on the preset amount of spring force k·x (see FIG. 6), which suppresses generation of the sliding frictions of each of the balls 5 and reduces the control deviation of the movable member 3. Further, suppression of the sliding frictions of each of the balls 5 makes it possible to suppress deterioration of abrasion resistance.

In a case where each of the balls 5 applies force exceeding the set amount of spring force k·x to one of the corresponding compression springs 21, the length of each of the compression springs 21 become the solid length as illustrated in FIG. 7C. Therefore, the further deformation of each of the compression springs 21 is restricted.

As described above, in the present embodiment, the compression springs 21 as the elastic bodies are provided on the wall parts 3b of each of the ball housing portions 3a of the movable member 3, and the impact from the balls 5 are buffered by the elastic deformation of the compression springs 21 in the state where generation of the sliding frictions is suppressed. Therefore, it is possible to achieve effects similar to the effects by the above-described first embodiment. Further, each of the compression springs 21 at the solid length functions as the restriction member. This makes it possible to easily set the elastic limit of each of the compression springs 21. Note that the elastic bodies are not limited to the compression springs 21 and may be compression rubbers.

What is claimed is:

1. A slide actuator comprising:
a fixed member;
a movable member movable to the fixed member by a predetermined stroke in a predetermined direction;
a plurality of balls interposed between the fixed member and the movable member and configured to movably support the movable member, each of the balls being disposed in the movable member; and
paired elastic bodies disposed at both ends of a moving range of each of the balls, each of the elastic bodies being configured to come into contact with the corresponding ball when the balls move with movement of the movable member.

2. The slide actuator according to claim 1, wherein each of the elastic bodies elastically deforms within a range in which generation of sliding frictions of the corresponding ball is suppressed when the balls come into contact with the respective elastic bodies at predetermined pressure or more.

3. The slide actuator according to claim 1, wherein a spring constant k of each of the elastic bodies is set within a following range,
(Fx/x2)<k≤(Fx/x1)
where Fx is a value obtained by adding maximum static frictional force between one of the balls and the fixed member to maximum static frictional force between the one of the balls and the movable member, x1 is a displacement amount of a contact point between each of the elastic bodies and the corresponding ball generated by the predetermined stroke of the movable member, and x2 is a displacement amount of a contact point between each of the elastic bodies and the corresponding ball at elastic limit of each of the elastic bodies.

4. The slide actuator according to claim 2, wherein a spring constant k of each of the elastic bodies is set within a following range,
(Fx/x2)<k≤(Fx/x1)
where Fx is a value obtained by adding maximum static frictional force between one of the balls and the fixed member to maximum static frictional force between the one of the balls and the movable member, x1 is a displacement amount of a contact point between each of the elastic bodies and the corresponding ball generated by the predetermined stroke of the movable member, and x2 is a displacement amount of a contact point between each of the elastic bodies and the corresponding ball at elastic limit of each of the elastic bodies.

5. The slide actuator according to claim 1, wherein the movable member includes restriction members restricting deformation of the elastic bodies beyond elastic limit, at both ends of the moving range of each of the balls.

6. The slide actuator according to claim 2, wherein the movable member includes restriction members restricting deformation of the elastic bodies beyond elastic limit, at both ends of the moving range of each of the balls.

7. The slide actuator according to claim 1, wherein the paired elastic bodies are disposed at an interval greater than a value that is obtained by adding a distance between the contact points of the respective elastic bodies with the corresponding ball, to ½ of the predetermined stroke of the movable member.

8. The slide actuator according to claim 2, wherein the paired elastic bodies are disposed at an interval greater than a value that is obtained by adding a distance between the contact points of the respective elastic bodies with the corresponding ball, to ½ of the predetermined stroke of the movable member.

9. The slide actuator according to claim 3, wherein
the slide actuator is a voice coil motor, and
the value Fx is set to a value obtained by adding a value that is obtained by adding urging force applied to the movable member to maximum static frictional force between the one of the balls and the movable member, to a value that is obtained by adding the urging force to maximum static frictional force between the one of the balls and the fixed member.

10. The slide actuator according to claim 4, wherein
the slide actuator is a voice coil motor, and
the value Fx is set to a value obtained by adding a value that is obtained by adding urging force applied to the movable member to maximum static frictional force between the one of the balls and the movable member, to a value that is obtained by adding the urging force to maximum static frictional force between the one of the balls and the fixed member.

11. A lens driving apparatus comprising:
a slide actuator including a fixed member, a movable member movable to the fixed member by a predetermined stroke in a predetermined direction, a plurality of balls interposed between the fixed member and the movable member and configured to movably support the movable member, each of the balls being disposed in the movable member, and paired elastic bodies disposed at both ends of a moving range of each of the balls, each of the elastic bodies being configured to come into contact with the corresponding ball when the balls move with movement of the movable member;
a lens;
a magnet; and
a coil, wherein
the movable member holds the lens,
the magnet is fixed to a periphery of the movable member, and
the coil is wound around an outer periphery of the fixed member.

12. The lens driving apparatus according to claim 11, wherein each of the elastic bodies elastically deforms within a range in which generation of sliding frictions of the corresponding ball is suppressed when the balls come into contact with the respective elastic bodies at predetermined pressure or more.

13. The lens driving apparatus according to claim 11, wherein a spring constant k of each of the elastic bodies is set within a following range,
(Fx/x2)<k≤(Fx/x1)
where Fx is a value obtained by adding maximum static frictional force between one of the balls and the fixed member to maximum static frictional force between the one of the balls and the movable member, x1 is a displacement amount of a contact point between each of the elastic bodies and the corresponding ball generated by the predetermined stroke of the movable member, and x2 is a displacement amount of a contact point between each of the elastic bodies and the corresponding ball at elastic limit of each of the elastic bodies.

14. The lens driving apparatus according to claim 12, wherein a spring constant k of each of the elastic bodies is set within a following range,
(Fx/x2)<k≤(Fx/x1)
where Fx is a value obtained by adding maximum static frictional force between one of the balls and the fixed member to maximum static frictional force between the one of the balls and the movable member, x1 is a displacement amount of a contact point between each of the elastic bodies and the corresponding ball generated by the predetermined stroke of the movable member, and x2 is a displacement amount of a contact point between each of the elastic bodies and the corresponding ball at elastic limit of each of the elastic bodies.
